(19) United States
(12) Patent Application Publication
(10) Pub. No.: US 2016/0042462 A1
(43) Pub. Date: Feb. 11, 2016

(54) SYSTEM AND METHOD FOR ADMINISTERING INSURANCE DATA TO MITIGATE FUTURE RISKS

(71) Applicant: Hartford Fire Insurance Company, Hartford, CT (US)

(72) Inventors: Lane G. Coonrod, West Hartford, CT (US); Isaac D. Adams, Canton, CT (US); Kelson P. Hughes, Pekin, IL (US)

(21) Appl. No.: 14/451,675

(22) Filed: Aug. 5, 2014

(51) Int. Cl. G06Q 40/08

(52) U.S. Cl. CPC G06Q 40/08

(57) ABSTRACT

According to some embodiments, information about a first set of insurance based data may be received along with information about a second set of insurance based data. An objective parameter associated with at least one of the first set of insurance based data and the second set of insurance based data may be determined. A value for an adjustable insurance policy parameter may be calculated such that it will modify the objective parameter, wherein the calculation is based at least in part on both: (i) the received information about the first set of insurance based data and (ii) the received information about the second set of insurance based data.

### BACKGROUND

Insurance policies may be associated with various parameters. For example, an automobile insurance policy might be associated with an insurance premium, a deductible amount, insurance limits, an amount of profit, etc. Moreover, changes to some of these parameters may impact other parameters. For example, increasing an insurance premium might increase an amount of profit associated with each individual insurance policy but, at the same time, might reduce a renewal rate associated with the policy. That is, changes to one type of insurance policy may impact other policies and/or policyholders in unexpected ways. As another example, a change in billing practice (e.g., setting a higher premium) might result in changes to deductibles and/or coverage levels by policyholders. Understanding how adjustments to various insurance parameters influence other insurance parameters can be an expensive, time consuming, and error-prone task, especially when there are a substantial number of insurance policy parameters involved and/or the relationships between those parameters are complex.

It would be desirable to provide systems and methods to facilitate the appropriate adjustment of insurance policy parameters in an automated, efficient, and accurate manner.

### SUMMARY OF THE INVENTION

According to some embodiments, systems, methods, apparatus, computer program code and means may be provided to facilitate an adjustment of insurance policy parameters in an automated, efficient, and accurate manner. In some embodiments, information about a first set of insurance based data may be received along with information about a second set of insurance based data. An objective parameter associated with at least one of the first set of insurance based data and the second set of insurance based data may be determined. A value for an adjustable insurance policy parameter may be calculated such that it will modify the objective parameter, wherein the calculation is based at least in part on both: (i) the received information about the first set of insurance based data and (ii) the received information about the second set of insurance based data.

A technical effect of some embodiments of the invention is an improved and computerized method of facilitating the adjustment of insurance policy parameters. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram of a decision analytics system according to some embodiments of the present invention.

FIG. 2 illustrates a decision analytics method according to some embodiments of the present invention.

FIG. 3 illustrates individual amounts of profit associated with two insurance policies according to some embodiments.

FIG. 4 illustrates overall profit associated with two insurance policies according to some embodiments.

FIG. 5 is block diagram of a decision analytics system according to some embodiments of the present invention.

FIG. 6 illustrates an optimization method according to some embodiments of the present invention.

FIG. 7 illustrates a user interface display in accordance with some embodiments.

FIG. 8 is an example of a decision analytics platform according to some embodiments.

FIG. 9 is a tabular portion of optimization decision analytics database according to some embodiments.

FIG. 10 illustrates a system architecture within which some embodiments related to policy insurance and decisioning may be implemented.

FIG. 11 is an example of a method that may be performed in accordance with some embodiments.

### DETAILED DESCRIPTION

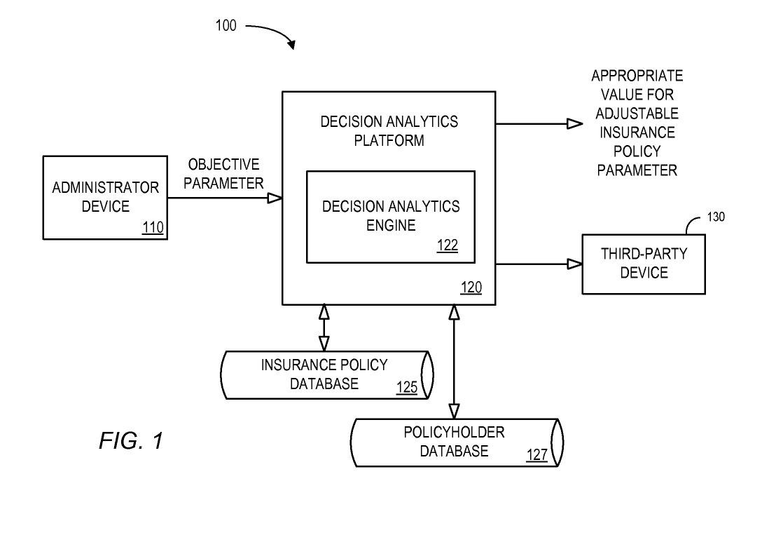

According to some embodiments described herein, algorithms and/or models may be used to “modify” a value for an objective parameter associated with an insurance policy. By ways of example only, the objective parameter might be optimized, minimized, maximized, etc. According to some embodiments, optimization may use one of an assortment of linear, nonlinear, or other programming algorithms such as simplex method, particle swarm optimization, or a steepest decent technique. Note that embodiments might use one or more different types of modification techniques, including an iterative-conjugate gradient technique, a steepest descent technique, a projected-conjugate gradient optimization, etc. To help facilitate the modification of insurance policy parameters, FIG. 1 is a block diagram of a system 100 according to some embodiments of the present invention. In particular, a decision analytics platform 120 may receive information from an administrator device 110. The decision analytics platform 120 might be associated with, for example, an insurance company or an entity that provides consumers with insurance coverage. The administrator device 110 might be associated with, for example, a Personal Computers (PC), laptop computer, hand-held computer, wireless device, or smartphone that can transmit information to and receive information from the decision analytics platform 120. Based on an indication of an objective parameter (that is, an indication of which parameter should be optimized), the decision analytics platform 120 may generate and output an appropriate value for one or more adjustable insurance policy parameters. According to some embodiments, the decision analytics platform 120 may also transmit information to a third party device 130, such as a device associated with underwriting, the creation of reports, an automatic workflow, etc.

According to some embodiments, an “automated” decision analytics platform 120 and/or decision analytics engine 122 may facilitate an exchange of information. As used herein, the term “automated” may refer to, for example, actions that can be performed with little or no human intervention. By way of example only, the decision analytics platform 120 and/or decision analytics engine 122 may include and/or communicate with a PC, an enterprise server, or a database farm.

As used herein, devices, including those associated with the decision analytics platform the 120, the decision analytics engine 122, and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The decision analytics platform 120 may access information in one or more insurance policy databases 125 and/or policyholder databases 127. The databases 125, 127 may include, for example, policyholder information, insurance policy parameters, and/or information about claims that have been filed in the past for similar types of insurance policies. As will be described further below, the databases 125, 127 may be used to help determine an appropriate value for an adjustable insurance policy parameter so as to “optimize” or otherwise modify an objective parameter. As used herein, the term “optimize” may refer to a maximum, minimum, or substantially improved value.

Although a single decision analytics platform 120 and a single decision analytics engine 122 are shown in FIG. 1, any number of such devices may be included. Moreover, various devices described herein might be combined according to embodiments of the present invention. For example, in some embodiments, the decision analytics platform 120 and insurance policy database 125 might be co-located and/or may comprise a single apparatus.

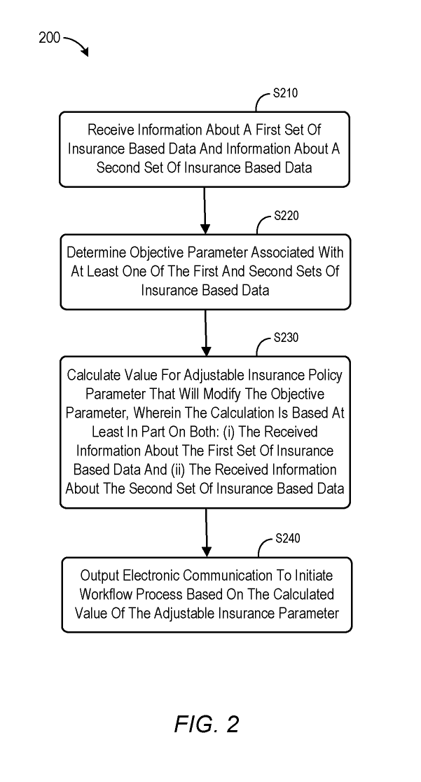

FIG. 2 illustrates a method that might be performed, for example, by some or all of the elements of the system 100 described with respect to FIG. 1 according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, information about a first set of insurance based data and information about a second set of insurance based data may be received. According to some embodiments, the first and second sets of insurance based data are associated with different lines of insurance policies. For example, a first insurance policy might be a homeowners insurance policy, and a second insurance policy might be an automobile insurance policy. Other examples of lines of insurance include, for example, workers' compensation insurances, short term disability insurance, long term disability insurance, health insurance, property insurance, liability insurance, fire insurance, motorcycle insurance, and business insurance. According to some embodiments, the first and second sets of insurance based data are associated with different types of policyholders (e.g., based on geographic location or types of insurance classifications). For example, the first set of insurance based data might be associated with women under the age of forty and the second set of insurance data might be associated with women who are at least forty years old.

At S220, an objective parameter associated with at least one of the first set of insurance based data and the second set of insurance based data may be determined. As used herein, a parameter might be “determined,” for example, by receiving an indication of the objective parameter from an administrator. For example, the administrator might select to have a “renewal rate” optimized or otherwise modified using a pull down menu on a display. As another example, the objective parameter might be determined by retrieving a pre-stored indication of the objective parameter (e.g., the system might always determine that an overall profit is to be optimized). The objective parameter may be associated with any quantifiable parameter that is to be modified, such as, without limitation, an overall amount of profit (e.g., profit from both a homeowners insurance policy and related automobile insurance policy), a homeowners insurance amount of profit, an automobile insurance amount of profit, an overall renewal rate, a homeowners renewal rate, and an automobile insurance renewal rate.

Note that some embodiments described herein may be used to modify any type of parameter associated with sets of insurance based data, including any type of profit, any type of renewal rate (e.g., optimizing renewal rates for women over 35 years old), an issue rate, a cancellation rate, a shopping rate, or an aging parameter. Moreover, embodiments may be associated with different types of models associated with insurance policies, such as a cost model, an expense model, a sales model, a marketing model, and/or an operating model. Other examples of objective parameters include a marginal value, a number of policies, Personal Umbrella Policy (“PUP”) information, a discounted value of any parameter, a net present value of any parameter, earnings, a discounted stream of absolute return on equity, and a rate or return on equity at a certain time. Note that embodiments may seek to optimize the objective parameter with respect to a fixed date (e.g., Jan. 1, 2020), a window of dates (e.g., over the next four fiscal quarters), a number of different policyholders (e.g., all policyholders who live in Nebraska), a total premium, and/or a total revenue.

At S230, a value for an adjustable insurance policy parameter may be calculated that will modify the objective parameter. Moreover, the calculation is based at least in part on both: (i) the received information about the first set of insurance based data and (ii) the received information about the second set of insurance based data. The adjustable insurance policy parameter may be associated with, for example, a base rate for the insurance policy, a rating factor (e.g., a risk factor that may be applied to the base rate), and/or a rating sub-factor. Other examples of adjustable insurance policy parameters include a deductible amount, an insurance limit, a product feature (e.g., TrueLane), a type of coverage, a billing practice, an underwriting guideline, and a price. Note that according to some embodiments, a plurality of adjustable insurance policy parameters may be calculated to optimize one or more objective parameters.

At S240, an electronic communication may be output to initiate a workflow process based on the calculated value of the adjustable insurance parameter. For example, the workflow process may include determining an insurance premium for an insurance policy based in part on the calculated value for the adjustable insurance parameter. In this case, the workflow might electronically transmit a quote to a potential insurance customer, the quote including an indication of the insurance premium. An indication of acceptance may then be received from the potential insurance customer, and, responsive to the received indication of acceptance, the workflow may automatically arrange for an insurance policy to be issued.

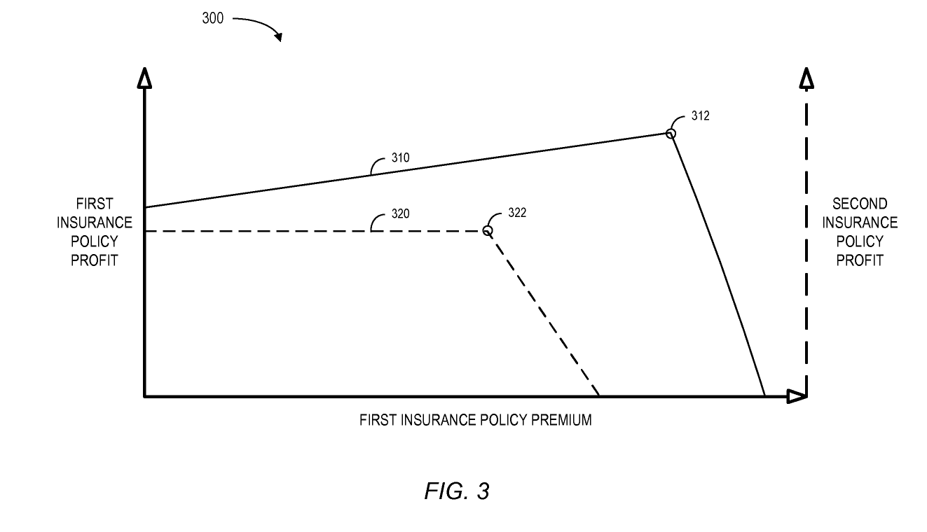

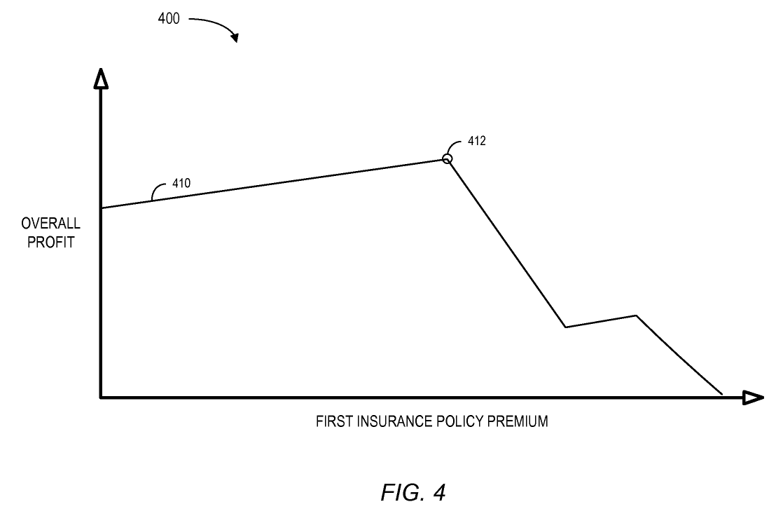

Because the adjustable parameter is modified with respect to both sets of insurance based data, the value of the objective parameter may be improved. Consider, for example, FIG. 3 which illustrates 300 individual amounts of profit associated with two insurance policies according to some embodiments. In particular, the profit associated with a first insurance policy 310 (illustrated with a solid line in FIG. 3) may initially steadily increase as the first insurance policy premium increases (along the x-axis). At a certain point 312, however, policyholders may begin to change insurance companies causing the amount of profit associated with the first insurance policy to decrease however. A typical optimization process would therefore determine that that point 312 is the “optimum” premium for the first insurance policy. Note that the amount of profit associated with a second insurance policy 320 (illustrated with a dashed line in FIG. 3) may initially be unchanged as the premium of the first insurance policy increases). However, it may be the case that a certain point 322, the profit associated with the second insurance policy may decrease as a result of increases in the premium for the first insurance policy. For example, an increase in life insurance premiums could cause policyholders to switch both of their life and health insurance policies to another insurance company. FIG. 4 illustrates 400 an overall profit 410 associated with both insurance policies according to some embodiments. Because information about both insurance policies are considered by the system, a different optimum price 412 for the first insurance policy may be determined.

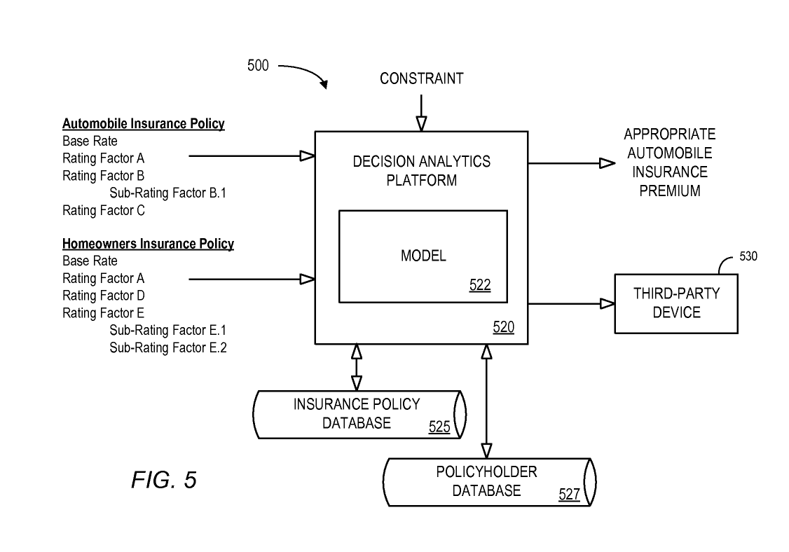

FIG. 5 is block diagram of decision analytics system 500 according to some embodiments of the present invention. As before, decision analytics platform 520 may receive information. The decision analytics platform 520 might be associated with, for example, an insurance company or an entity that provides consumers with insurance coverage. Based on information about an automobile insurance policy (e.g., a base rate, rating factors, and sub-rating factors), the decision analytics platform 520 may generate and output an appropriate premium value for automobile insurance premium. According to some embodiments, the decision analytics platform 520 may also transmit information to a third party device 530, such as a device associated with underwriting, the creation of reports, an automatic workflow, etc. By way of example only, the decision analytics platform 520 and/or model 522 may include and/or communicate with a PC, an enterprise server, or a database farm. Moreover, the decision analytics platform the 520, the model 522, and any other device described herein, may exchange information via any communication network which may be one or more networks.

The decision analytics platform 520 may access information in one or more insurance policy databases 525 and/or policyholder databases 527. The databases 525, 527 may include, for example, policyholder information, insurance policy parameters, and/or information about claims that have been filed. As will be described further below, according to some embodiments the insurance rating factors and sub rating factors may be simultaneously adjusted to determine an optimum objective parameter.

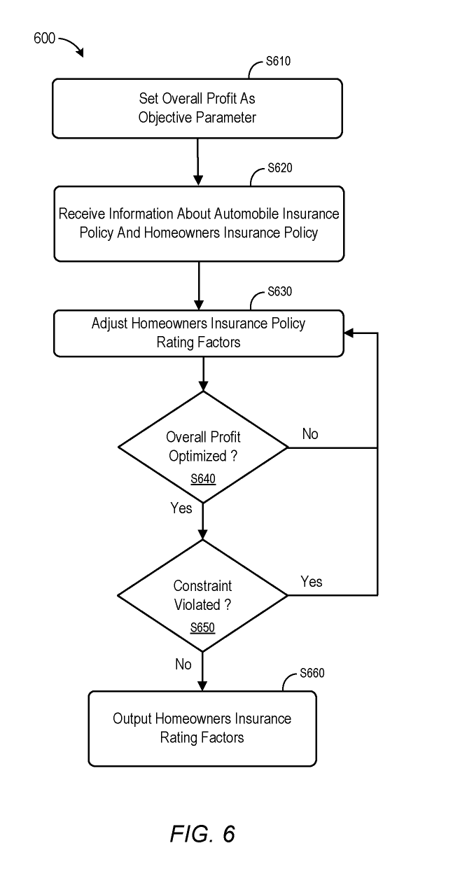

FIG. 6 illustrates a method that might be performed, for example, by some or all of the elements of the system 500 described with respect to FIG. 5 according to some embodiments of the present invention. At S610, “overall profit” associated with an automobile insurance policy and a homeowners insurance policy may be set as the objective parameter. At S620, information about the automobile insurance policy and information about the homeowners insurance policy may be received. The homeowners insurance policy rating factors may be automatically adjusted at S630 until it is determined at S640 that the overall profit has been maximized.

According to some embodiments, one or more constraints may be associated with the optimization process. For example, if it is determined at S650 that a constraint has been violated, the calculation of values for the adjustable insurance policy parameters may continue at S630. If the constraint was not violated, the homeowners insurance policy ratings factors may be output at S660. By way of examples only, a constraint might be associated a financial value (e.g., premium limit), a number of insurance policies, a number of insurance policyholders, underwriting guidelines, a combined ratio, and/or an insurance book. Note that any number of constraints may be associated with an optimization process (e.g., more than a single constraint may be applied simultaneously) and the constraints may be associated with any types of values, including pricing, a profit limitation associated with a regulation, rating restrictions (e.g., associated with credit scores), etc.

According to some embodiments, the adjustment of an insurance parameter may include a determination as to a likelihood of a future occurrence. That is, the calculated value for the adjustable insurance policy parameter may further be based on the likelihood of the future occurrence, such as an occurrence associated with marriage, home ownership, automobile ownership, children and/or any other event that changes a risk profile. Consider, for example, an automobile insurance policy that is issued to a married man who is thirty-five years old. The optimization process may determinate that a married man that age is likely to purchase a house in the next five years, and that information (and associated potential profit associated with a new homeowners insurance policy) may be used to help optimize parameters.

Note that risks may be evaluated at new business based on a current profile of a driver, a car, a home, as well as a multitude of other present day characteristics. However, given that many policyholders maintain a relationship with an insurance carrier for a substantial period of time, a modeled ratemaking step may adjust a price at new business for a likely future improvement in risk profile. This method of ratemaking may use algorithms and decision making techniques to price an insurance product based on a likely future benefits to be realized through risk profile improvement. A multitude of tradeoffs might, for example, be formally quantified and balanced using advanced mathematical techniques. Such a system that relies upon future risk profile improvement as an element of the tradeoff analysis may solve the problem of pricing at new business solely based on current risk profile. A dynamic view of a risk may be utilized as opposed to a static view.

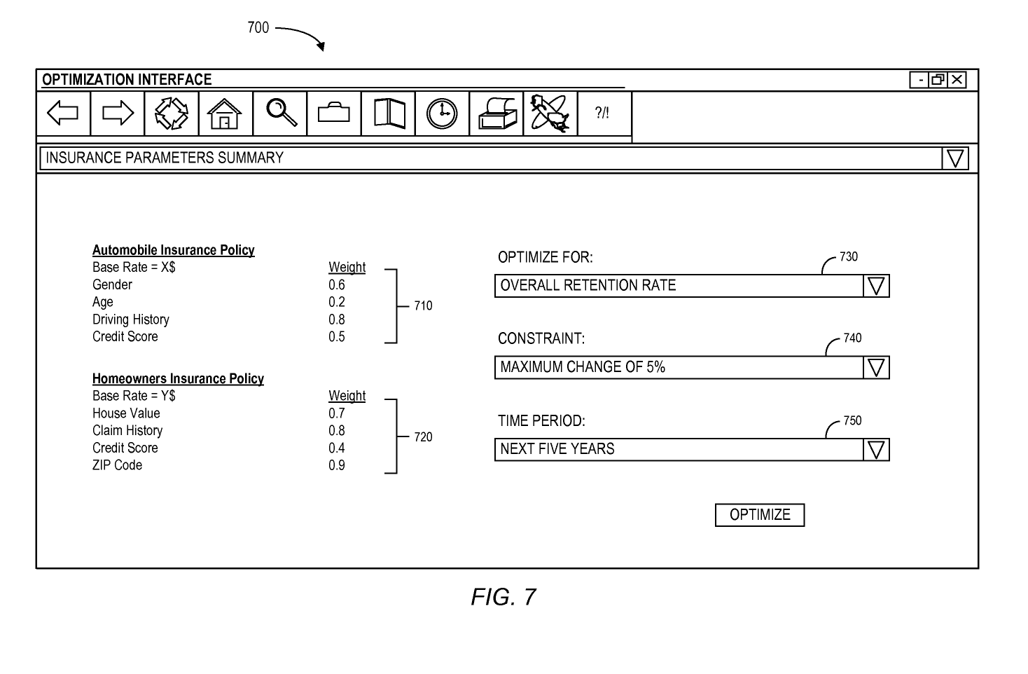

FIG. 7 illustrates a user interface display 700 in accordance with some embodiments. The display 700 includes rating factors 710 for an automobile insurance policy along with associated weights for those factors. Similarly, the display 700 includes rating factors 720 for a homeowners insurance policy along with associated weights for those factors. Note that different rating factors may be associated with each policy (although some factors may be shared by both).

The display 700 further includes an optimization selection 730 that lets an administrator determine which parameter will be optimized (e.g., by selecting an “overall retention rate” indication). The administrator may also use a constraint selection 740 (e.g., to indicate that no changes over 5% should be suggested) and a time period selection 750 (e.g., to indicate that the overall retention rate should be optimized over the next five years).

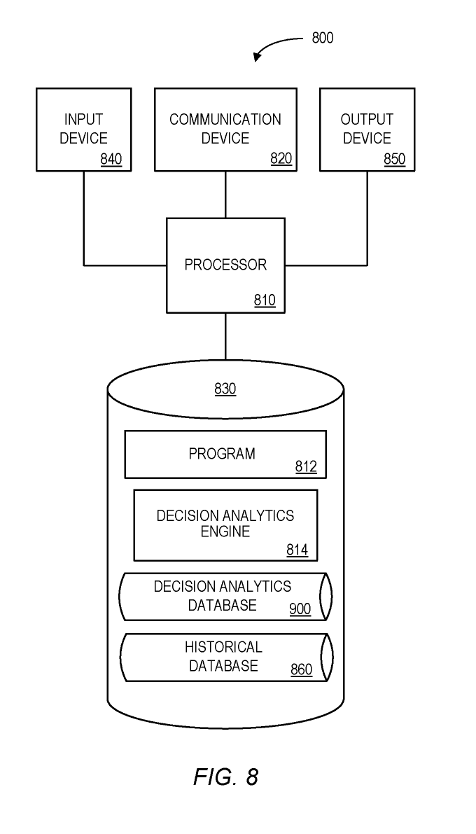

The embodiments described herein may be implemented using any number of different hardware configurations. For example, FIG. 8 illustrates decision analytics platform 800 that may be, for example, associated with the optimization platform 120 of FIG. 1. The decision analytics platform 800 comprises a processor 810, such as one or more commercially available Central Processing Units (CPUs) in the form of one-chip microprocessors, coupled to a communication device 820 configured to communicate via a communication network (not shown in FIG. 8). The communication device 820 may be used to communicate, for example, with one or more administrator devices, remote databases, and/or third-party devices. The decision analytics platform 800 further includes an input device 840 (e.g., a mouse, video camera, and/or keyboard to enter insurance parameters and optimization selections) and an output device 850 (e.g., a computer monitor to display results and/or generate reports).

The processor 810 also communicates with a storage device 830. The storage device 830 may comprise any appropriate information storage device, including combinations of magnetic storage devices (e.g., a hard disk drive), optical storage devices, mobile telephones, vehicle computers, and/or semiconductor memory devices. The storage device 830 stores a program 812 and/or decision analytics engine 814 for controlling the processor 810. The processor 810 performs instructions of the programs 812, 814, and thereby operates in accordance with any of the embodiments described herein. For example, the processor 810 may receive information about a first set of insurance based data along with information about a second set of insurance based data. The processor 810 may also determine an objective parameter associated with at least one of the first insurance policy and the second insurance policy. A value for an adjustable insurance policy parameter may be calculated by the processor 810 such that it will modify the objective parameter, wherein the calculation is based at least in part on both: (i) the received information about the first set of insurance based data and (ii) the received information about the second set of insurance based data.

The programs 812, 814 may be stored in a compressed, uncompiled and/or encrypted format. The programs 812, 814 may furthermore include other program elements, such as an operating system, a database management system, and/or device drivers used by the processor 810 to interface with peripheral devices.

As used herein, information may be “received” by or “transmitted” to, for example: (i) the optimization platform 800 from another device; or (ii) a software application or module within the optimization platform 800 from another software application, module, or any other source.

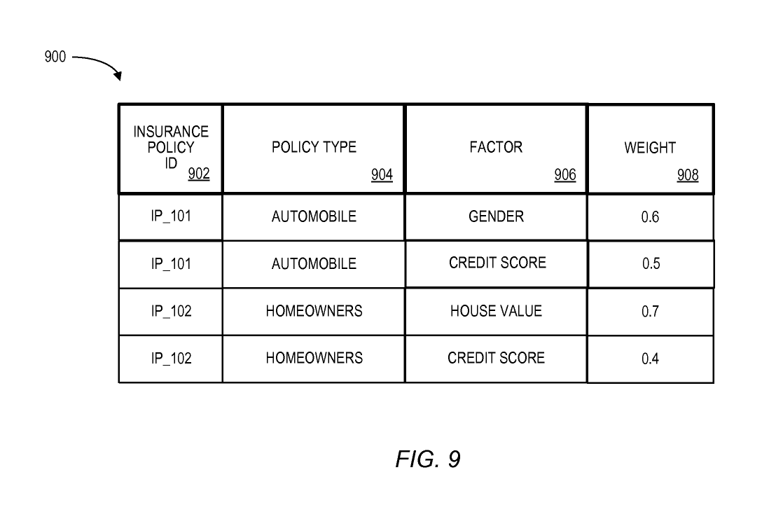

In some embodiments (such as shown in FIG. 8), the storage device 830 stores a decision analytics database 900 (described with respect to FIG. 9) and historical database (e.g., indicating previously paid claims for similar insurance policies). An example of a database that might be used in connection with the decision analytics platform 800 will now be described in detail with respect to FIGS. 9. Note that the databases and displays described herein are only examples, and additional and/or different information may be provided. Moreover, various databases might be split or combined in accordance with any of the embodiments described herein.

FIG. 9 is a tabular portion of a decision analytics database 900 according to some embodiments. The table may include, for example, entries identifying insurance policies that have been sold to policyholders. The table may also define fields 902, 904, 906, 908 for each of the entries. The fields 902, 904, 906, 908 may, according to some embodiments, specify: an insurance policy identifier 902, a policy type 904, a factor 906, and a weight 908. The information in the decision analytics database 900 may be created and updated, for example, by an optimization engine.

The insurance policy identifier 902 may be, for example, a unique alphanumeric code identifying an insurance policy that has been sold to a policy holder. The policy type 904 may indicate the type of insurance associated with the policy and the factors 906 may include risk factors used to price the insurance policy in accordance with the associated weights 908. A decision analytics engine may adjust those weights 908, according to some embodiments, using information about a number of different insurance policy identifiers.

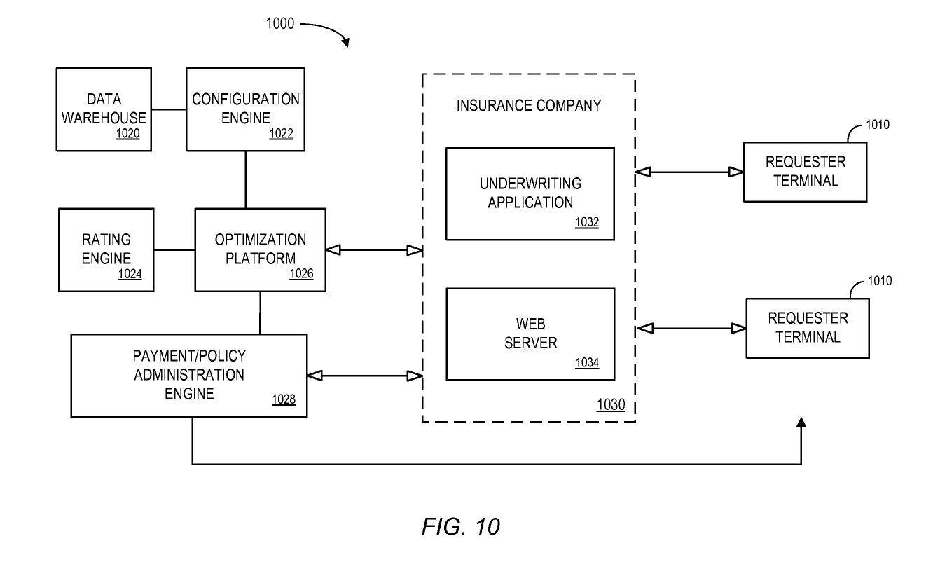

Features of some embodiments will now be described by first referring to FIG. 10 which illustrates a system architecture 1000 within which some embodiments may be implemented. More particularly, FIG. 10 depicts a system architecture 1000 in which comprehensive protection plans, including optimized values, may be quoted, priced, issued and managed. Although the devices of architecture 1000 are depicted as communicating via dedicated connections, it should be understood that all illustrated devices may communicate to one or more other illustrated devices through any number of other public and/or private networks, including but not limited to the Internet. Two or more of the illustrated devices may be located remote from one another and may communicate with one another via any known manner of network(s) and/or a dedicated connection. Moreover, each device may comprise any number of hardware and/or software elements suitable to provide the functions described herein as well as any other functions. Other topologies may be used in conjunction with other embodiments.

According to the example architecture shown in FIG. 10, a number of requestor terminals 1010 are provided which comprise devices that may be operated by an insurance agent, a consumer, etc. seeking a recommendation of insurance coverages or information about policies. Requestor terminals 1010 may interact with Web pages provided by Web server 1034 to request a recommendation and to provide data relating to the kinds of property to be insured and information about the customer. This data may be transmitted to the insurance systems 1030 to determine a recommendation as described in detail below. The requests may be received from individuals or entities seeking insurance coverage or for requests for insurance information. For example, the application data submitted via a requestor terminal 1010 may include information about a business, information about the insured, information about the limits and other options requested, or the like, but embodiments are not limited thereto.

As used herein, an insurance coverage “package” may comprise a set of one or more insurance coverages or policy features. In the present description, an insurance coverage defines the parameters of the risk(s) which are covered thereby, and a configuration is a package of one or more insurance coverages, including in some cases specified limits and deductibles for each of the one or more insurance coverages. Any number of requestor terminals 1010 may be employed to receive customer and insurance request data and to present insurance coverage and other information to operators of the requestor terminals 1010.

The requestor terminals 1010 may be in communication with an insurance company 1030 or other provider via a Web server 1034 or other front end interface that allows remote terminals to send and receive data to the insurance company. The customer and insurance request data are received via the Web server 1034 and are stored by data warehouse 1020 for later action. Any number or type of data storage systems may store the data in any suitable manner according to some embodiments. Non-exhaustive examples include a relational database system, a spreadsheet, and any other data structure that is amenable to parsing and manipulating data. A data warehouse 1020 may receive and store customer and application data as well as store insurance coverage package data and rules which are used in by an optimization platform 1026 (e.g., associated with a quoting engine) and the configuration engine 1022. Although the illustration of FIG. 10 shows an optimization being performed in response to a request for an insurance quote, note that the optimization platform 1026 may instead adjust insurance policy parameters on a periodic basis.

The configuration engine 1022 acts to receive the customer or insurance request data and to retrieve insurance coverage package data and rules from the data warehouse 1020. A configuration engine 1022 may identify one or more insurance coverage packages based on the received data and on data received from Web server 1034. Pursuant to some embodiments, different insurance packages are assembled for presentation to the customer based on configuration rules and information associated with each policy term.

When an appropriate package (or packages) is identified by the configuration engine 1022, the package may be priced using the optimization platform 1026 and/or underwriting device and then presented to the customer or agent via a Web page or other user interface for viewing on a display screen of a requestor terminal 1010.

Note that each of the engines or platforms 1022, 1024, 1026, 1028 and the insurance systems 1030 may comprise any combination of hardware and/or processor-executable instructions stored on a tangible medium. According to some embodiments, one or more of the engines or platforms 1022, 1024, 1026 or 1028 may be a component of the data warehouse 1020 or the insurance systems 1030.

It should be noted that embodiments are not limited to the devices illustrated in FIG. 10. Each device may include any number of disparate hardware and/or software elements, some of which may be located remotely from one another. Functions attributed to one device may be performed by one or more other devices in some embodiments. The devices of system 1000 may communicate with one another (and with other non-illustrated elements) over any suitable communication media and protocols that are or become known.

Thus, embodiments may be associated with predictive models in connection with an automobile insurance issue rate (taking into account any influence on homeowners insurance), a homeowners issue rate (taking into account any influence on automobile insurance), and/or a retention model for automobile and/or homeowners insurance. Other examples may be associated with: associated cancellation, shopping, aging, and/or profile or characteristic change models, cost models for both automobile and homeowners insurance; expense models to quantify and allocate expenses; sales models, marketing models, and operating models; and/or any other model or process associated with predicting attributes of insurance customers, insurance business, and insurance economics.

Note that an objective function might be associated with an outcome involving both automobile and homeowners insurance, such as a total marginal number of customers, a total number of automobile insurance policies or items, a total number of homeowners insurance policies or items, total PUP information, a discounted or net present value of total earnings or profit, a discounted stream of absolute return on equity, a rate or return on equity at a certain time, or any other calculated value that may be in the interests of an insurance organization to maximize (or minimize).

The constraints described herein might be associated with, for example, the rating factors in automobile insurance class plans, the rating factors in homeowners insurance class plans, base rates in either plan, underwriting guidelines, and may be associated with aggregate constraints (e.g., automobile combined ratio, homeowners combined ratio, total personal lines combined ratio, total property and casualty combined ratio, a measured premium increase in a certain book, a number of total customers, and/or any other measurable financial or operational metric.

The mechanics of optimization may involve first extracting and preparing datasets of automobile insurance quotes, automobile in-force policyholders, homeowners insurance quotes, homeowners in-force policyholders, and/or any other associated dataset that may facilitate the quantification of an objective function, constraints, and/or summary information. Next, there may be demand models created for all lines and all consumer decisions, such as cancellation and issue. A premium might be an input into these demand models (which could be logistic regressions but could instead be associated with another functional form). An optimization algorithm may determine the set of rating factors or other product related actions that increases the objective function to its maximum level while still satisfying all constraints. Regardless of algorithm used, the objective function may be evaluated through a change in the premium, which may change the inputs into the demand functions, which may change the business outcome, which may be measured and increased to a maximum point. According to some embodiments, multiple years may be evaluated, along with multiple lines, companies, businesses, constraints, and/or other parameters that may be put into a mathematical function or described algebraically.

One example of an analysis may use an operations research engine (algorithm/solver such as gradient descent class of algorithm like projected conjugate gradient) to simultaneously find the best price points for both automobile and homeowners insurance products (in any number of books, companies, underwriting groups, etc.) given the objective function that is considered the measure of “best” such that all defined constraints are satisfied.

As another example, an optimization process may be associated with marketing, which has a conversion rate model. This may also be considered as an input into a decision-making framework. For example, one data input might be the population of people eligible to become quotes, the type of people, a model that describes how those people get converted into quotes given certain marketing dollar investments, and/or a simulator for the absolute level of quotes. In this example, marketing spending (and the areas where the spending occurs) may be considered a level in the optimization (i.e., something that can change within a defined range to yield a higher amount of an objective function). Note that an issue rate model may also predict the probabilities for each quote to become a policyholder, and demand models may predict probabilities that each current policyholder will remain a policy holder.

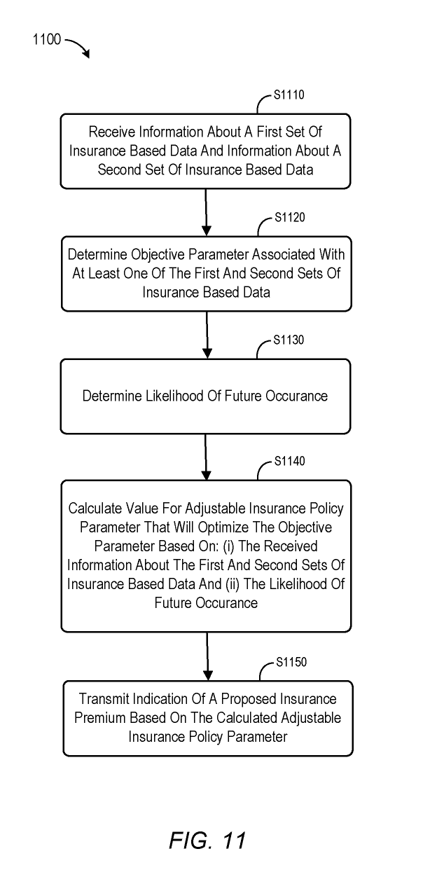

Note that future predicted events associated with a policyholder may, according to some embodiments, be used to mitigate future risks. For example, FIG. 11 illustrates a method that may be performed according to some embodiments. At S1110, information about a first set of insurance based data and information about a second set of insurance based data may be received. According to some embodiments, the first and second sets of insurance based data are associated with different lines of insurance policies. At S1120, an objective parameter associated with at least one of the first set of insurance based data and the second set of insurance based data may be determined. For example, the administrator might select to have an “overall profit” optimized.

At S1130, a determination may be made as to a likelihood of a future occurrence of an event, such as an occurrence associated with marriage, home ownership, automobile ownership, children and/or any other event that changes a risk profile. Consider, for example, an automobile insurance policy that is issued to an unmarried man who is twenty-five years old. An optimization process may determinate that an unmarried man who is that age is very likely to become married over the next five years.

At S1140, a value for an adjustable insurance policy parameter may be calculated that will optimize the objective parameter. Moreover, the calculation may be based at least in part on both: (i) the received information about the first and second sets of insurance based data and (ii) the likelihood of the future occurrence of the event determined at S1130. The adjustable insurance policy parameter may be associated with, for example, a base rate for the insurance policy, a rating factor (e.g., a risk factor that may be applied to the base rate), and/or a rating sub-factor. At S1150, an electronic communication may be transmitted, including a proposed insurance premium based on the calculated adjustable insurance policy parameter. By way of example, consider a 23 year-old policyholder who has Financial Responsibility (“FR”) limits. The rating factors suggested by an optimization analysis may increase prices for this segment while the rate for a 25 year-old homeowner with high limits may be decreased. According to some embodiments, the optimization process may recognize that there is a certain probability that the 23 year-old renter will eventually stay with the company and become 25 years-old. That is, the individual may be on the cusp of a very different risk profile. This expected appreciation in risk profile may be incorporated in connection with the prediction models and/or dynamic simulation techniques in accordance with some embodiments.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

Applicants have discovered that embodiments described herein may be particularly useful in connection with insurance premium quotes. Note, however, that other types of insurance information may also be associated with embodiments described herein. For example, embodiments of the present invention may be used in connection with insurance deductibles, co-pay amounts, etc.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system using an iterative-conjugate gradient technique to process insurance based data to mitigate future risks, comprising:
a communication device to receive information about a first set of insurance based data and information about a second set of insurance based data;
a computer processor for executing program instructions; and
a memory, coupled to the computer processor, for storing program instructions for execution by the computer processor to:
determine an objective parameter associated with at least one of the first set of insurance based data and the second set of insurance based data;
calculate, using the iterative-conjugate gradient technique, a value for an adjustable insurance policy parameter that will modify the objective parameter, wherein the calculation is based at least in part on both: (i) the received information about the first set of insurance based data and (ii) the received information about the second set of insurance based data; and
output an electronic communication to initiate a workflow process based on the calculated value of the adjustable insurance parameter.

2. The system of claim 1, wherein the first and second sets of insurance based data are associated with different insurance classifications.

3. The system of claim 1, wherein the modification of the objective parameter is associated with at least one of: (i) optimization, (ii) minimization, and (iii) maximization.

4. The system of claim 1, wherein the memory further stores program instructions for execution by the computer processor to:
determine an insurance premium for an insurance policy based in part on the calculated value for the adjustable insurance parameter;
electronically transmit a quote to a potential insurance customer, the quote including an indication of the insurance premium;
receive an indication of acceptance from the potential insurance customer; and
responsive to the received indication of acceptance, arrange for an insurance policy to be issued.

5. The system of claim 1, wherein said determination is associated with at least one of: (i) receiving an indication of the objective parameter from an administrator, and (ii) retrieving a pre-stored indication of the objective parameter.

6. The system of claim 1, wherein the first and second sets of insurance based data are associated with different lines of insurance.

7. The system of claim 6, wherein at least one line of insurance is associated with: (i) homeowners insurance, (ii) automobile insurance, (iii) workers' compensation insurance, (iv) short term disability insurance, (v) long term disability insurance, (vi) health insurance, (vii) property insurance, (viii) liability insurance, (ix) fire insurance, and (x) business insurance.

8. The system of claim 6, wherein the first set of insurance based data is associated with homeowners insurance policies, the second set of insurance based data is associated with automobile insurance policies, and the adjustable insurance policy parameter is associated with an insurance premium for one of an automobile insurance policy and a homeowners insurance policy.

9. The system of claim 8, wherein the objective parameter is associated with at least one of: (i) an overall amount of profit, (ii) a homeowners insurance amount of profit, (iii) an automobile insurance amount of profit, (iv) an overall renewal rate, (v) a homeowners renewal rate, and (vi) an automobile insurance renewal rate.

10. The system of claim 8, wherein the adjustable insurance policy parameter is associated with at least one of: (i) a base rate, (ii) a rating factor, and (iii) a rating sub-factor.

11. The system of claim 1, wherein the objective parameter is associated with at least one of: (i) an amount of profit, (ii) a renewal rate, (iii) an issue rate, (iv) a cancellation rate, (v) a shopping rate, (vi) an aging parameter, (vii) a cost model, (viii) an expense model, (ix) a sales model, (x) a marketing model, (xi) an operating model, (xii) a marginal value, (xiii) a number of policies, (xiv) personal umbrella policy information, (xv) a discounted value of any parameter, (xvi) a net present value of any parameter, (xvii) earnings, (xviii) a discounted stream of absolute return on equity, (xix) a rate or return on equity at a certain time, (xx) a fixed date, (xxi) a window of dates, (xxii) a number of policyholders, (xxiii) a total premium, and (xxiv) a total revenue.

12. The system of claim 1, wherein the adjustable insurance parameter is associated with at least one of: (i) a base rate, (ii) a rating factor, (iii) a rating sub-factor, (iv) a deductible amount, (v) an insurance limit, (vi) an insurance product feature, (vii) a type of coverage, (viii) a billing practice, (ix) an underwriting guideline, and (x) a price.

13. The system of claim 1, wherein the memory further stores program instructions for execution by the computer processor to:
determine a constraint, wherein the calculated value for the adjustable insurance policy parameter is further based on the constraint.

14. The system of claim 13, wherein the constraint is associated with at least one of: (i) a financial value, (ii) a number of insurance policies, (iii) a number of insurance policyholders, (iv) underwriting guidelines, (v) a combined ratio, and (vi) an insurance book.

15. The system of claim 1, wherein the memory further stores program instructions for execution by the computer processor to:
determine a likelihood of a future occurrence, wherein the calculated value for the adjustable insurance policy parameter is further based on the likelihood of the future occurrence.

16. The system of claim 15, wherein the future occurrence is associated with: (i) marriage, (ii) home ownership, (iii) automobile ownership, (iv) children, or (v) any other event that changes a risk profile.

17. The system of claim 1, wherein the first and second sets of insurance based data are associated with different policyholders.

18. The system of claim 1, wherein values for a plurality of adjustable insurance policy parameters are calculated to optimize the objective parameter.

19. The system of claim 1, wherein a plurality of objective parameters are modified.

20. A method to process insurance based data to mitigate future risks, comprising:
receiving information about a first set of insurance based data and information about a second set of insurance based data;
determining an objective parameter associated with at least one of the first set of insurance based data and the second set of insurance based data;
determining a likelihood of a future occurrence, wherein the determination is based on at least one of: (i) a database containing information about past behaviors, and (ii) a third party service;
automatically calculating, by a processor of a decision analytics engine, a value for an adjustable insurance policy parameter that will modify the objective parameter, wherein the calculation is based at least in part on both: (i) the received information about the first and second sets of insurance based data and (ii) the determined likelihood of the future occurrence; and
outputting an electronic communication to initiate a workflow process based on the calculated value of the adjustable insurance parameter.

21. The method of claim 20, wherein the first and second sets of insurance based data are associated with: (i) different lines of insurance and (ii) a single policyholder.

22. The method of claim 21, wherein the objective parameter is associated with at least one of: (i) an overall amount of profit, (ii) a homeowners insurance amount of profit, (iii) an automobile insurance amount of profit, (iv) an overall renewal rate, (v) a homeowners renewal rate, and (vi) an automobile insurance renewal rate.

23. A non-transitory, computer-readable medium storing instructions adapted to be executed by one or more computer processors to perform a method associated with an adjustable insurance policy parameter, the method comprising:
receiving information about a first set of insurance policies and information about a second set of insurance policies, the first and second sets of insurance policies being associated with different insurance classifications;
determining an objective parameter associated with at least one of the first set of insurance policies and the second set of insurance policies; and
calculating a value for the adjustable insurance policy parameter that will optimize the objective parameter, wherein the calculation is based at least in part on both: (i) the received information about the first set of insurance policies and (ii) the received information about the second set of insurance policies.

24. The medium of claim 23, wherein the first and second sets of insurance policies are associated with different lines of insurance.

25. The medium of claim 23, wherein the objective parameter is associated with at least one of: (i) an overall amount of profit, (ii) a homeowners insurance amount of profit, (iii) an automobile insurance amount of profit, (iv) an overall renewal rate, (v) a homeowners renewal rate, and (vi) an automobile insurance renewal rate.

26. The medium of claim 25, wherein the method further comprises receiving information about a third set of insurance policies, and the calculation is further based on the received information about the third set of insurance policies.
